(19) United States
(12) Patent Application Publication
(10) Pub. No.: US 2013/0248257 A1
(43) Pub. Date: Sep. 26, 2013

(54) Drilling Fluid Composition

(71) Applicants: Mathieu Naegel, Strasbourg (FR); Michel Gregoire, Poey de Lescar (FR); David Pasquier, Lyon (FR); Isabelle Henaut, Rueil-Malmaison (FR); Sara Rovinetti, Garbagnate Milanese (IT); Vincent Pierre Meunier, Waterloo (BE)

(72) Inventors: Mathieu Naegel, Strasbourg (FR); Michel Gregoire, Poey de Lescar (FR); David Pasquier, Lyon (FR); Isabelle Henaut, Rueil-Malmaison (FR); Sara Rovinetti, Garbagnate Milanese (IT); Vincent Pierre Meunier, Waterloo (BE)

(73) Assignees: Solvay Specialty Polymers Italy, Milano (IL); IFP Energies Nouvelles, Rueil-Malmaison Cedex (FR); Total S.A., Coubevoie (FR)

(21) Appl. No.: 13/810,754

(22) PCT Filed: Jul. 18, 2011
(86) PCT No.: PCT/EP2011/062186

§ 371 Date: May 31, 2013

(30) Foreign Application Priority Data
Jul. 22, 2010 (EP) 10305809.5

(51) Int. Cl. C09K 8/36

(52) U.S. Cl. CPC C09K 8/36
USPC 175/393; 507/105

(57) ABSTRACT

The invention pertains to a drilling fluid composition comprising:—at least one (per)fluoropolyether oil comprising recurring units of formula —CF(CF3)CF2O— said oil having a kinematic viscosity of 30 to 80 cSt measured according to ASTM D455 standard at 20° C. [oil (E)] and possessing a polydispersity index (PDI) of at least 1.15; and—at least one (per)fluoropolyether phosphate comprising at least one perfluoropolyoxyalkylenic chain and at least one phosphoric acid group, in its acid, amide, salt or ester form [phosphate (P)], to a method for its manufacture and to its use in a drilling rig equipment.

This application claims priority to European application No. 10305809.5 filed on Jul. 22, 2010, the whole content of this application being incorporated herein by reference for all purposes.

### TECHNICAL FIELD

The present invention relates to a drilling fluid of optimized composition intended to solve problems encountered during operations such as drilling, completion or workover operations in a well, in particular for exploration and exploitation of deeply buried reservoirs.

### BACKGROUND ART

In drilling boreholes for exploring or exploiting oil and/or natural gas reservoirs, drilling fluid, otherwise known as drilling muds are used. The main functions of drilling fluids include:
providing hydrostatic pressure to prevent fluids coming from the reservoir from entering into the well bore;
lubricating and keeping the drill bit cool and clean during drilling;
carrying out drill cuttings, and
suspending the drill cuttings while drilling is paused and when the drilling assembly is brought in and out of the hole.

The drilling fluid used for a particular job is selected to avoid damages to the geological formation hosting the reservoir and to limit corrosion.

After more than a century of operating in highly diverse settings, onshore and offshore, oil companies have combed most of the world's geographical and geological environments. One area, however, remains largely uncharted and that is deeply-buried reservoirs. This extreme challenge is now tackled for facing the worldwide increasing demand for crude oil.

Temperatures close to 300° C. at a depth of more than 6,000 meters and pressures of over 1,500 bar, conditions generally encountered in these deeply-buried reservoirs, require the development of new techniques and drilling tools and the qualification of new materials that can help wells withstand this below-ground inferno over long periods of time. There is thus currently a shortfall in the art for mud composition suitable for drilling, completion or workover operations in wells on deeply-buried reservoirs.

What is referred to as completion is all the preparation or outfitting operations required for bringing in a geologic formation from the wellbore. These completion operations use particular fluids called completion fluids.

What is referred to as workover is all the operations carried out in a producing or potentially producing well. Workover fluids can be used in the producing well in circulation in a comparable manner to drilling fluids, or in form of a spacer fluid.

A feature that all these drilling, completion or workover fluids have in common is the physico-chemical suitability of their formulation to the nature of the geologic formations they are in contact with and to the main functions they are intended for.

The main problems encountered when using fluids under HP/HT (high pressure/high temperature) conditions are essentially due to the following two constraints:
a well fluid density above 2000 kg/m³ is required in order to balance the bottomhole pressure at great well depths,
the bottomhole static temperatures are often much higher than 200° C., and they can sometimes reach or even exceed 300° C.

To provide a solution to this problem, in US 2007123430 (INSTITUT FRANCAIS DU PETROLE) May 31, 2007 the use of a liquid fluorinated compound, in particular of a (per)fluoropolyether, as main constituent of the continuous phase of well fluids has been proposed. By combining said (per)fluoropolyether with an aqueous phase of brine, possibly in the presence of a suitable fluorinated emulsifier, and with an inorganic filler like barite, muds suitable as drilling fluids are obtained.

Nevertheless, mud compositions therein disclosed are not optimized in terms of viscosity profile, stability of the mud and thermal resistance.

There is thus still a need in the art for an improved drilling mud enabling operations in wells in deeply-buried reservoirs.

### DISCLOSURE OF INVENTION

The invention thus pertains to a drilling fluid composition comprising:
at least one (per)fluoropolyether oil comprising recurring units of formula —CF(CF₃)CF₂O—
   said oil having a kinematic viscosity of 30 to 80 cSt measured according to ASTM D455 standard at 20° C. [oil (E)] and possessing a polydispersity index (PDI) of at least 1.15; and
at least one (per)fluoropolyether phosphate comprising at least one perfluoropolyoxyalkylenic chain and at least one phosphoric acid group, in its acid, amide, salt or ester form; [phosphate (P)].

The Applicant has found that the particular combination of the oil (E) as above defined, having branched perfluoropolyether recurring units, possessing well defined kinematic viscosity and having a particular polydispersity index, and the phosphate (P) enables achieving outstanding performances in mud stability, even after long exposure to severe conditions (temperatures as high as 300° C.) and rheological behaviour, which make the same suitable for operation in drilling boreholes in deeply-buried reservoirs.

The oil (E) is preferably selected from the following classes:

B—O—[CF(CF₃)CF₂O]_{b1′}(CFXO)_{b2′}—B′ (1)

wherein:
X is equal to —F or —CF₃;
B and B′, equal to or different from each other, are selected from —CF₃, —C₂F₅ or —C₃F₇;
b1′ and b2′, equal or different from each other, are independently integers≧0 selected such that the b1′/b2′ ratio is comprised between 20 and 1,000 and b1′+b2′ is in the range 5 to 250; should b1′ and b2′ be both different from zero, the different recurring units are generally statistically distributed along the chain.
   Said products can be obtained by photooxidation of the hexafluoropropylene as described in CA 786877 (MONTEDISON S.P.A.) Apr. 6, 1968, whose disclosures are herein incorporated by reference, and by subsequent conversion of the end groups as described in GB 1226566 (MONTECATINI EDISON S.P.A.) Mar. 3, 1971 whose disclosures are herein incorporated by reference;

C₃F₇O—[CF(CF₃)CF₂O]_{o′}-D (2)

wherein
D is equal to —C₂F₅ or —C₃F₇;
o′ is an integer from 5 to 250.
   Said products can be prepared by ionic hexafluoropropylene epoxide oligomerization and subsequent treatment with fluorine as described in U.S. Pat. No. 3,242,218 (DU PONT) Mar. 22, 1966, whose disclosures are herein incorporated by reference;

{C₃F₇O—[CF(CF₃)CF₂O]_{dd′}—CF(CF₃)—}₂ (3)

wherein
dd′ is an integer between 2 and 250.
   Said products can be obtained by ionic telomerization of the hexafluoropropylene epoxide and subsequent photochemical dimerization as reported in U.S. Pat. No. 3,214,478 (DU PONT) Oct. 26, 1965 whose disclosures are herein incorporated by reference; and

C′—O—[CF(CF₃)CF₂O]_{c1′}(C₂F₄O)_{c2′}(CFX)_{c3′}—C″ (4)

wherein
X is equal to —F or —CF₃;
C′ and C″, equal to or different from each other, are selected from —CF₃, —C₂F₅ or —C₃F₇;
c1′, c2′ and c3′ equal or different from each other, are independently integers≧0, such that and c1′+c2′+c3′ is in the range 5 to 250; should at least two of c1′, c2′ and c3′ be different from zero, the different recurring units are generally statistically distributed along the chain.
   Said products can be manufactured by photooxidation of a mixture of C₃F₆ and C₂F₄ and subsequent treatment with fluorine as described in U.S. Pat. No. 3,665,041 (MOTENDISON S.P.A.) May 23, 1972, whose disclosures are herein incorporated by reference.

The oil (E) possesses a polydispersity index (PDI) of at least 1.15; the polydispersity index (PDI) is hereby expressed as the ratio of weight average molecular weight (M_{w}) to number average molecular weight (Mₙ), as determined notably by GPC, wherein:
weight average molecular weight (M_{w}) is:

$${M}_{w} = \frac{\sum {M}_{i}^{2} \cdot {N}_{i}}{\sum {M}_{i} \cdot {N}_{i}}$$

number average molecular weight (Mₙ) is:

$${M}_{n} = \frac{\sum {M}_{i} \cdot {N}_{i}}{\sum {N}_{i}}$$

The Applicant has surprisingly found that drilling fluids compositions, otherwise complying with all above mentioned requirements, but failing to possess a PDI exceeding 1.15, do not possess adequate thermal stability to withstand operating conditions typically encountered in exploitation of deeply buried reservoirs; only those drilling fluids complying with this requirement maintain appropriate characteristics, including e.g. stable dispersion of solids and aqueous phase even after prolonged exposure to temperatures as high as 300° C.

Upper value of the polydispersity index (PDI) is not particularly limited; while broadening molecular weight distribution from high molecular weight side is not an issue, provided kinematic viscosity requirement is fulfilled; it is nevertheless preferred that the oil (E) will not comprise extremely low molecular weight fraction. To this aim, oils (E) will in certain embodiments be selected among those comprising less than 10% wt, preferably less than 8% wt, more preferably less than 5% wt of fractions having molecular weight of less than 1000 Dalton.

Typically, the oil (E) possesses a polydispersity index (PDI) of 1.15 to 2.0, preferably of 1.15 to 1.85, more preferably of 1.15 to 1.25.

The oil (E) possesses a kinematic viscosity of 30 to 80 cSt measured according to ASTM D455 standard at 20° C.; kinematic viscosities values exceeding 80 cSt are not suited for this application; similarly oils (E) having kinematic viscosities of less than 30 cSt do not perform correctly when used in drilling fluids compositions.

Oils which have been found to provide particularly good results within the drilling fluid compositions of the invention are those possessing a kinematic viscosity of 35 to 75 cSt, preferably of 40 to 65 cSt, when measured according to ASTM D455 standard at 20° C.

The drilling mud composition of the invention generally comprises the phosphate (P) in an amount of 0.1 to 5% by volume, with respect to the total volume of the fluid.

The Applicant has surprisingly found that among functional (per)fluoropolyether compounds, phosphate (P) as above detailed is advantageously particularly effective for ensuring suitable stabilization of the drilling fluid and for retaining such stabilization efficiency even after prolonged operations at high temperatures.

Phosphate (P) is preferably selected from the group consisting of compounds complying with any of formulae P-1, P-2 and P-3:

[R^{P′}_{f}—CFYCH₂—O-L]ₘ—P(O)(OZ₁)₃₋ₘ (formula P-1)

R^{P″}_{f}-[CFYCH₂—O-L′-P(O)(OZ₂)(OZ₃)]₂ (formula P-2)

Z₅O—(OZ₄)P(O)-L″-O—CH₂CFY—R^{P″}_{f}—CFYCH₂O-L″]ᵥ—P(O)(OZ₆)(OZ₇) (formula P-3)

wherein:
m=1 to 3;
Y is —F or —CF₃;
L, L′, L″, equal to or different from each other and at each occurrence, are a bond or a bivalent linking groups;
v is an integer from 1 to 10, preferably from 1 to 5;
Z₁, Z₂, Z₃, Z₄, Z₅, Z₆ and Z₇, equal to or different from each other, are selected from H, alkaline or ammonium group, and R^{P}_{f}—CF₂CH₂—O-L-group;
R^{P′}_{f} is a monovalent (per)fluoropolyoxyalkylenic chain comprising fluorine and catenary ether atoms in the chain and terminated by a C₁-C₃ (per)fluoroalkyl group possibly comprising one or more halogens, in particular Cl, Br;
R^{P″}_{f} is a divalent (per)fluoropolyoxyalkylenic chain comprising fluorine and catenary ether atoms in the chain.

The (per)fluoropolyoxyalkylenic chains R^{P′}_{f} and R^{P″}_{f} of formulae P-1, P-2, P-3 are preferably chains comprising recurring units (R₁), said recurring units having general formula: —(CF₂)ₖ—CFZ_{f}—O—, wherein k is an integer of from 0 to 3 and Z_{f} is selected between a fluorine atom and a C₁-C₆ perfluoro(oxy)alkyl group.

Chain R^{P′}_{f} more preferably complies with formula:

R_{Fa}—O—(CF₂CF₂O)_{a′}(CFYO)_{b′}(CF₂CFY′O)_{c′}(CF₂O)_{d′}(CF₂(CF₂)_{z′}CF₂O)_{e′}—,

the recurring units being statistically distributed along the (per)fluoropolyoxyalkylene chain, wherein:
Y is —F or —CF₃;
Y′ is a C₁-C₅ perfluoro(oxy)alkyl group;
z′ is 1 or 2;
a′, b′, c′, d′, e′ are integers≧0,
R_{Fa} is a C₁-C₃ (per)fluoroalkyl group, possibly comprising halogens (Cl, Br in particular).

Chain R^{P″}_{f} more preferably complies with formula:

—(CF₂CF₂O)_{a″}(CFYO)_{b″}(CF₂CFY″O)_{c″}(CF₂O)_{d″}(CF₂(CF₂)_{z″}CF₂O)_{e″}—,

the recurring units being statistically distributed along the (per)fluoropolyoxyalkylene chain, wherein:
Y″ is a C₁-C₅ perfluoro(oxy)alkyl group;
z″ is 1 or 2;
a″, b″, c″, d″, e″ are integers≧0.

Most preferably, chain R^{P′}_{f} complies with formula:

R_{Fa}—O—(CF₂CF₂O)_{a′}(CF₂O)_{b′}(CF₂(CF₂)_{z′}CF₂O)_{c′}—,

wherein:
z′ is 1 or 2;
a′, b′, c′ are integers≧0,
R_{Fa} is a C₁-C₃ (per)fluoroalkyl group, possibly comprising halogens (Cl, Br in particular).

Most preferably, chain R^{P″}_{f} complies with formula:

—(CF₂CF₂O)_{a″}(CF₂O)_{b″}(CF₂(CF₂)_{z″}CF₂O)_{c″}—,

wherein:
z″ is 1 or 2;
a″, b″, c″ are integers≧0.

In above formulae P-1, P-2, P-3, groups L, L′, L″ are generally selected from linking groups of formula: —(CH₂CH₂O)ₖ—, with average value for k being comprised between 1 and 5.

A phosphate which has been found to yield particularly good result is a phosphate of formula:

Z*₅O—[(OZ*₄)P(O)—(OCH₂CH₂)ₖ*—O—CH₂CFY*—(CF₂CF₂O)_{a*}(CF₂O)_{b*(}CF₂(CF₂)_{z*}CF₂O)_{c*}—CFY*CH₂O—(CH₂CH₂O)_{k*}]_{v*}—P(O)(OZ*₆)(OZ*₇)

wherein:
Y* is —F or —CF₃;
Z*₄, Z*₅, Z*₆ and Z*₇, equal to or different from each other, are selected from H, alkaline or ammonium group;
k* is comprised between 1 and 3, preferably between 1 and 2;
z* is 1 or 2;
a*, b*, c* are integers≧0;
v* is an integer from 1 to 5, preferably from 1 to 3.

The drilling fluid composition of the invention generally comprises an aqueous phase.

The drilling fluid composition advantageously is suited to withstand a massive brine inflow from the reservoir rock; to this aim is therefore advantageously formulated in form of a reverse water emulsion comprising a continuous phase comprising the oil (E) as main constituent.

Thus, according to a preferred embodiment, the drilling fluid composition comprises said oil (E) as main component of a continuous phase in admixture with an aqueous dispersed phase; phosphate (P) as above detailed advantageously enables appropriate stabilization of this aqueous dispersed phase in a continuous phase mainly consisting of oil (E).

The aqueous phase generally comprises, preferably consists essentially of brines. The brines can be aqueous solutions of sodium, potassium and/or calcium halides (generally chlorides), sodium and/or potassium carbonates, alkaline formates and the like.

A brine which has been found to provide particularly good result is a calcium chloride brine.

The drilling fluid composition generally contains at least 1%, sometimes at least 2%, otherwise at least 3% by volume (with respect to the total volume of the drilling fluid composition) of an aqueous phase, this latter generally dispersed in the oil (E) phase.

The drilling fluid composition generally contains at most 80%, sometimes at most 60%, otherwise at most 50% by volume (with respect to the total volume of the drilling fluid composition) of said aqueous phase, this latter generally dispersed in the oil (E) phase.

Good results have been obtained with drilling fluid compositions comprising 5 to 40% by volume (with respect to the total volume of the drilling fluid composition) of said aqueous phase, this latter generally dispersed in a phase comprising oil (E) as main component.

The drilling fluid composition further advantageously comprises at least one weighting material; this weighting material is generally intended to ensure tuning of the density of the composition to target value. Typically inorganic weighting materials are used. The choice of the weighting material is not critical, provided that it remains substantially inert in drilling fluid composition during its manufacture and use. Among weighting materials, barite is preferred for its high density and inertness. Amount of weighting agent is generally selected as a function of the other ingredients; typically the composition will comprise from 5 and 25% by volume of weighting agent, with respect to the total volume of the drilling fluid composition.

The invention pertains also a method for manufacturing the drilling fluid composition as above detailed.

The method generally comprises mixing the oil (E) and the phosphate (P) as above defined. Mixing can be performed in any appropriate equipment, including high speed homogenizers, stirred tanks, emulsifiers and the like.

Typically, additional ingredients, like notably the aqueous phase and the weighting material as above detailed can be additionally admixed with the oil (E) and the phosphate (P) to obtain the drilling fluid composition. It is nevertheless generally preferred to add these ingredients to a pre-mixed admixture of oil (E) and phosphate (P) as above detailed.

The invention further pertains to the use of the drilling fluid composition in a drilling rig equipment.

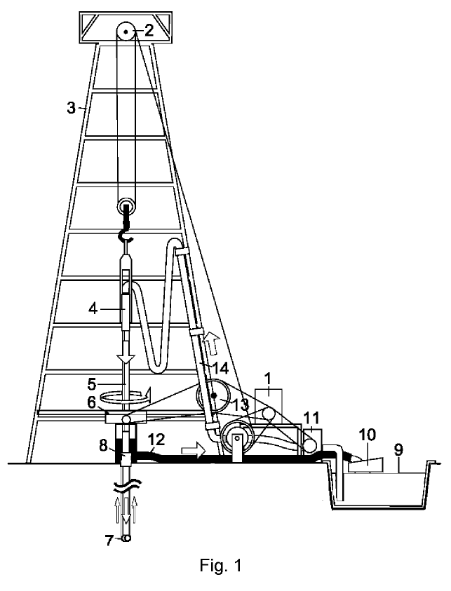

FIG. 1 schematically depicts drilling rig equipment wherein the mud composition of the invention can be used.

In this equipment a drill pipe or string (#5) acts as a conduit for the drilling fluid; it is generally made of joints of hollow tubing connected together and stood in the derrick vertically. A drill bit (#7) device is attached to the end of the drill string; this bit breaks apart the rock being drilled. It also contains jets through which the drilling fluid exits. The rotary table (#6) or a top drive (not shown) rotates the drill string along with the attached tools and bit.

A mechanical section or drawworks section (#13) contains the spool, whose main function is to reel in/out the drill line to raise/lower the travelling block.

A mud pump (#11) is used to circulate drilling fluid through the system; the mud is suctioned from the mud tank or mud pit (#9) which provides a reserve store of drilling fluid. The mud flows through the conduit #14 and through the drill pipe (#5) down to the bit (#7). Loaded with drill cuttings it flows upwards in the borehole and is extracted through the conduit (#12) back to the mud pit. A shale shaker (#10) separates drill cuttings from the drilling fluid before it is pumped back down the borehole.

The equipment can further comprise devices installed at the wellhead to prevent fluids and gases from unintentionally escaping from the borehole (not shown).

Should the disclosure of any of the patents, patent applications, and publications that are incorporated herein by reference conflict with the present description to the extent that it might render a term unclear, the present description shall take precedence.

The invention will be now described in more details with reference to the following examples whose purpose is merely illustrative.

Base Oils

Properties of base oils used for formulating the drilling mud compositions are listed in table 1 herein below:

TABLE 1

| | | Density | | | |
|---|---|---|---|---|---|
| | PDI | (g/ml) at | Kinematic Viscosity (cSt) | | |
| PFPE type | (M_{w}/Mₙ) | 20° C. | 20° C. | 40° C. | 100° C. |
| 2045X⁽¹⁾ | 1.21 | 1.87 | 63 | 25 | 4.5 |
| Y04⁽²⁾ | 1.02 | 1.87 | 38 | 15 | 3.2 |

⁽¹⁾FOMBLIN^{(R)} 2045X is a (per)fluoropolyether oil having branched structure available from Solvay Solexis S.p.A.;
⁽²⁾FOMBLIN^{(R)} Y04 is a (per)fluoropolyether oil having branched structure commercially available from Solvay Solexis S.p.A., which was used for formulate a comparative mud composition.

Both the FOMBLIN® 2045×PFPE and the FOMBLIN® Y04 PFPE belong to the family of branched PerFluoroPolyEthers, and have been manufactured by reaction of hexafluoropropene (HFP) and oxygen catalyzed by UV light. Branched PerFluoroPolyEthers have the following chemical structure:

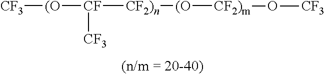

Branched PerFluoroPolyEthers (PFPE) are characterized by an outstanding thermal resistance (up to more than 300° C.) and chemical resistance to very aggressive environments.
The FOMBLIN® 2045X PFPE and the FOMBLIN® Y04 PFPE represent respectively a broader and narrower “cuts” of Molecular Weight Distribution (MWD) obtained by fractional distillation of the same matrix of branched PFPEs.

(Per)Fluoropolyether Phosphate

A (per)fluoropolyether phosphate, which is a mixture of mono- and diphosphoric PFPE esters, complying with formula:

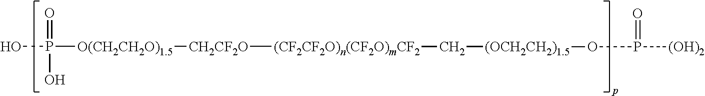

p=1 for the phosphoric monoester, p≧2 for the phosphoric diester
p=1 about 70% mol
p≧2 about 30% mol
n/m=0.8-2.5
and commercially available from Solvay Solexis S.p.A. under trade name FLUOROLINK® F10 PFPE has been used. This compound was manufactured by reaction of diphosphorous pentoxide, orthophosphoric acid or pyrophosphoric acid with an ethoxylated perfluoroether diol.

General Procedure for Manufacturing the Drilling Mud Compositions

The ingredients, as detailed below in Table 2, were mixed using a homogenizer Ultra Turrax T25. To prepare a 200 ml sample, the ingredients were introduced as follows:

1—introduction of PFPE oil (279.7 g)
2—introduction of phosphate (P) (1.384 g) followed by stirring for 5 minutes;
3—introduction of CaCl₂ brine (at 300 g/l) (22.4 g) followed by stirring for 15 minutes;
4—introduction of barite (134.4 g) followed by stirring for 15 minutes.
During all the above steps, rotational speed of the homogenizer was set at 11 000 rpm at room temperature.

Two typical examples of ingredients used for producing the inventive drilling fluid compositions are detailed in Table 2.

TABLE 2

| Mud | Composition | % by volume |
|---|---|---|
| 1 | Fomblin ® 2045X PFPE | 73.6 |
| | Fluorolink ® F10 PFPE | 0.4 |
| | CaCl₂ brine (300 g/l) | 10 |
| | Barite | 16 |
| 2 | Fomblin ® Y04 PFPE | 73.6 |
| comparative | Fluorolink ® F10 PFPE | 0.4 |
| | CaCl₂ brine (300 g/l) | 10 |
| | Barite | 16 |

Rheological and Thermal Characterization.

The rheological characterization was carried out at different temperatures using the controlled stress rheometer Haake 150 with a 40 mm sanded plate geometry.

In order to test its thermal resistance, the mud samples were introduced into sealed gold tubes placed inside an autoclave. This set up enabled to heat the samples at temperatures up to 300° C. during 24 hours, with an external pressure of 100 bar.

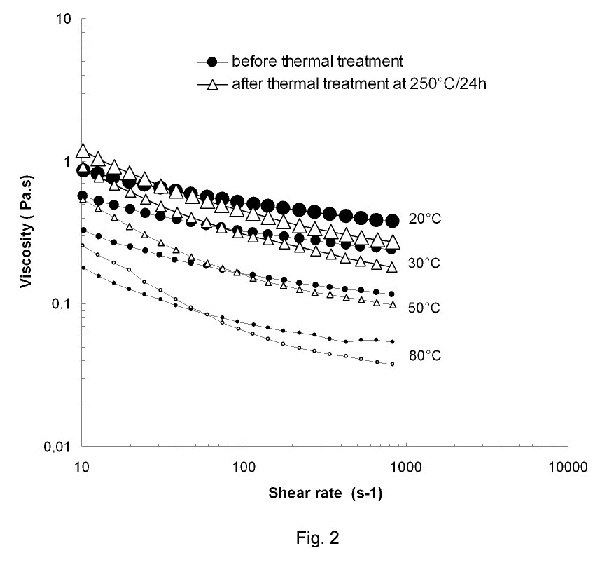

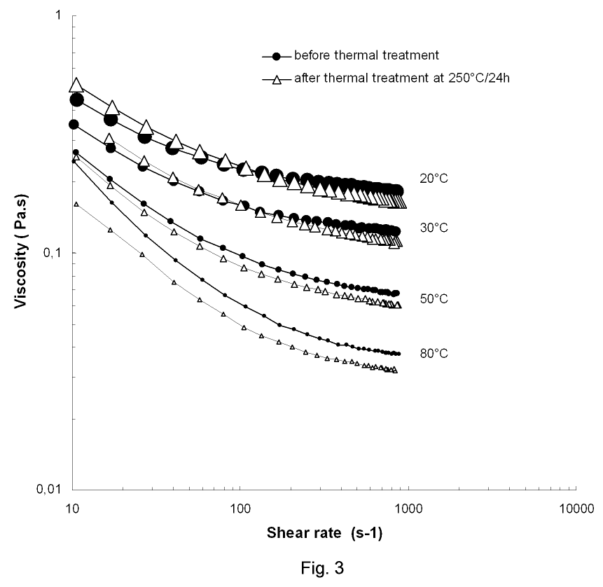

FIGS. 2 and 3 show the flow curves of muds 1 and 2, respectively, before and after the thermal treatment at 250° C. for 24 h.

The flow curves before and after the thermal treatment almost superimpose, demonstrating the excellent thermal stability of the muds. Also the visual appearance of the muds appears unchanged after the thermal test.

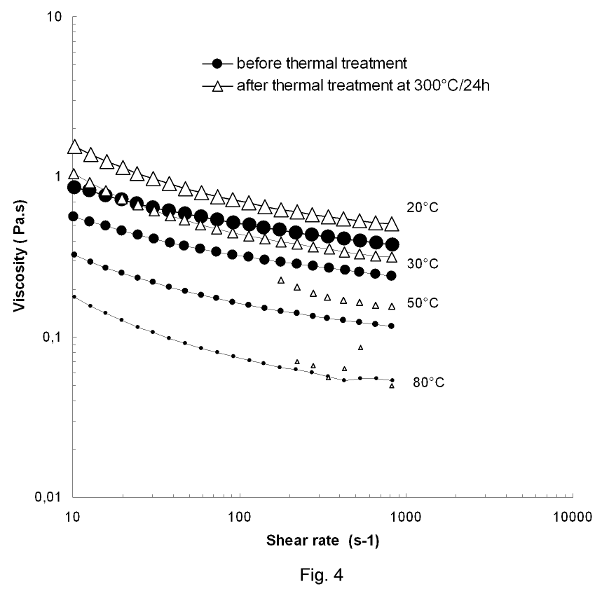

When the same test was performed at 300° C. for 24 hours, it was surprisingly found that the mud 1 retained its fluidity and original appearance after the thermal test (see FIG. 4), while the mud 2 appeared heterogeneous and its flow curves could not even be measured.

This test demonstrates that only the mud 1 was found to be able to withstand temperatures as high as 300° C.: without being bound by this theory, the Applicant believes that this particularly high thermal stability can be ascribed to the specific combination of Kinematic Viscosity and Molecular Weight Distribution of the base oil 2045×, which, combined with the use of phosphate (P) as effective dispersing agent, provides outstanding behaviour.

1. A drilling fluid composition comprising:
at least one (per)fluoropolyether oil comprising recurring units of formula —CF(CF₃)CF₂O— said oil having a kinematic viscosity of 30 to 80 cSt measured according to ASTM D455 standard at 20° C. [oil (E)] and possessing a polydispersity index (PDI) of at least 1.15; and
at least one (per)fluoropolyether phosphate comprising at least one perfluoropolyoxyalkylenic chain and at least one phosphoric acid group, in its acid, amide, salt or ester form [phosphate (P)].

2. The drilling fluid composition of claim 1, wherein the oil (E) is selected from the following classes:
B—O—[CF(CF₃)CF₂O]_{b1′}(CFXO)_{b2′}—B′ (1)
wherein:
X is equal to —F or —CF₃;
B and B′, equal to or different from each other, are selected from —CF₃, —C2F₅ or —C₃F₇;
b1′ and b2′, equal or different from each other, are independently integers selected such that the b1′/b2′ ratio is comprised between 20 and 1,000 and b1′+b2′ is in the range 5 to 250; should b1′ and b2′ be both different from zero, the different recurring units are generally statistically distributed along the chain.
C₃F₇O—[CF(CF₃)CF₂O]_{o′}-D (2)
wherein
D is equal to —C2F₅ or —C₃F₇;
o′ is an integer from 5 to 250.
{C3F₇O—[CF(CF₃)CF₂O]_{dd′}—CF(CF₃)—}₂ (3)
wherein
dd′ is an integer between 2 and 250.
C′—O—[CF(CF₃)CF₂O]_{c1′}(C₂F₄O)_{c2′}(CFX)_{c3′}—C″ (4)
wherein
X is equal to —F or —CF₃;
C′ and C″, equal to or different from each other, are selected from —CF₃, —C₂F₅ or —C₃F₇;
c1′, c2′ and c3′ equal or different from each other, are independently integers≧0, such that and c1′+c2′+c3′ is in the range 5 to 250; should at least two of c1′, c2′ and c3′ be different from zero, the different recurring units are generally statistically distributed along the chain.

3. The drilling fluid composition of claim 1, wherein the oil (E) possesses a polydispersity index (PDI) of 1.15 to 2.0, preferably of 1.15 to 1.85, more preferably of 1.15 to 1.25.

4. The drilling fluid composition of claim 1 wherein the oil (E) possesses a kinematic viscosity of 40 to 60 cSt, measured according to ASTM D455 standard at 20° C.

5. The drilling fluid composition of claim 1, wherein phosphate (P) is selected from the group consisting of compounds complying with any of formulae P-1, P-2 and P-3:
[R^{P′}_{f}—CFYCH₂—O-L]ₘ—P(O)(OZ₁)₃₋ₘ (formula P-1)
R^{P″}_{f}-[CFYCH₂—O-L′-P(O)(OZ₂)(OZ₃)]₂ (formula P-2)
Z₅O—(OZ₄)P(O)-L″-O—CH₂CFY—R^{P″}_{f}—CFYCH₂O-L″]ᵥ—P(O)(OZ₆)(OZ₇) (formula P-3)
wherein:
m=1 to 3;
Y is —F or —CF₃;
L, L′, L″, equal to or different from each other and at each occurrence, are a bond or a bivalent linking groups;
v is an integer from 1 to 10, preferably from 1 to 5;
Z₁, Z₂, Z₃, Z₄, Z₅, Z₆ and Z₇, equal to or different from each other, are selected from H, alkaline or ammonium group, and R^{P}_{f}—CF₂CH₂—O-L- group;
R^{P′}_{f} is a monovalent (per)fluoropolyoxyalkylenic chain comprising fluorine and catenary ether atoms in the chain and terminated by a C₁-C₃ (per)fluoroalkyl group possibly comprising one or more halogens, in particular Cl, Br;
R^{P″}_{f} is a divalent (per)fluoropolyoxyalkylenic chain comprising fluorine and catenary ether atoms in the chain.

6. The drilling fluid composition of claim 5, wherein the phosphate (P) complies with formula:
Z*₅O—[(OZ*₄)P(O)—(OCH₂CH₂)_{k*}—O—CH₂CFY*—(CF₂CF₂O)_{a*}(CF₂O)_{b*}(CF₂(CF₂)_{z*}CF₂O)_{c*}—CFY*CH₂O—(CH₂CH₂O)_{k*}]_{v*}—P(O)(OZ*₆)(OZ*₇)
wherein:
Y* is —F or —CF₃;
Z*₄, Z*₅, Z*₆ and Z*₇, equal to or different from each other, are selected from H, alkaline or ammonium group;
k* is comprised between 1 and 3, preferably between 1 and 2;
z* is 1 or 2;
a*, b*, c* are integers≧0;
v* is an integer from 1 to 5, preferably from 1 to 3.

7. The drilling fluid composition of claim 1, said composition comprising an aqueous phase.

8. The drilling fluid composition of claim 7, said composition being formulated in the form of a reverse water emulsion comprising a continuous phase comprising the oil (E) as main constituent.

9. The drilling fluid composition of claim 8, said composition comprising said oil (E) as main component of a continuous phase in admixture with an aqueous dispersed phase comprising one or more than one brines.

10. The drilling fluid composition according to claim 7, said composition comprising 5 to 40% by volume of said aqueous phase, with respect to the total volume of the drilling fluid composition.

11. The drilling fluid composition according to claim 1, said composition further comprising at least one weighting material.

12. The drilling fluid composition of claim 11, wherein said weighting agent is barite.

13. The drilling fluid composition according to claim 11, comprising from 5 to 25% by volume of weighting agent, with respect to the total volume of the drilling fluid composition.

14. A method for manufacturing the drilling fluid composition according to claim 1, said method comprising mixing the oil (E) and the phosphate (P).

15. A drilling rig equipment comprising the drilling fluid composition according to claim 1.

16. The drilling rig equipment of claim 15 in which a drill pipe or string acts as a conduit for said drilling fluid composition, a drill bit device is attached to the end of the drill string, said bit containing jets through which said drilling fluid composition exits.
